(19) United States
(12) Patent Application Publication
(10) Pub. No.: US 2005/0050254 A1
(43) Pub. Date: Mar. 3, 2005

(54) Apparatus for preventing the theft of laptop computers

(75) Inventor: David Boisvert, Meriden, CT (US)

Correspondence Address: THE MILLER LAW OFFICES, PLC, 801 BRICKELL AVE, SUITE 900, MIAMI, FL, 33131, US

(73) Assignee: BG & G, Inc.

(21) Appl. No.: 10/619,133

(22) Filed: Jul. 13, 2003

Related U.S. Application Data
(60) Provisional application No. 60/395,961, filed on Jul. 14, 2002.

(51) Int. Cl. G06F 12/00

(52) U.S. Cl. 710/200

(57) ABSTRACT

An apparatus for preventing the theft of laptop computers. with a self contained secure enclosure for a laptop computer, a way to mount the enclosure in a vertical orientation, a keyless mechanism to access enclosure, a way to better prevent access to the security enclosure, a way to notify the owner of unauthorized access to the enclosure, a way to notify the owner of unauthorized attempts to access the enclosure, a way to limit access to enclosure to authorized personnel, a way to determine which authorized personnel have accessed the secure enclosure, a way to provide authorized emergency access to the enclosure, a way to enhance backup electrical power for the enclosure, and a way to notify the owner of reduced available electrical power.

### CROSS REFERENCE TO RELATED APPLICATIONS

This application is a conversion, under 37 CFR 1.53(c)(3), of a provisional application No. 60/395,961 filed Jul. 14, 2002 into a non-provisional utility application.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of devices for preventing the theft of laptop computers.

Due to their relatively small geometric profile, light weight and important value, laptop computers have been subject to theft since their original introduction into the market. This problem is more acute for college students, who generally do not have the privacy or secure arrangements in dormitory living to properly secure their laptop computers from theft. Traditional solutions have been bulky safes resting on the floor or bracketing arrangements mounted to desks. Neither of these solutions is practical for a college student residing in a dormitory, where housing rules generally preclude these solutions. Earlier laptop computer security technologies used bulky floor resting safes desk mounted cables and desk mounted brackets. This invention proposes to be mounted on a structurally rigid and secure vertical surface (wall), thereby providing greater security than furniture attached security devices. No furniture will be damaged.

The earlier technology of using bulky floor resting safes was not secure in that the entire safe could be easily stolen from the dormitory room. The earlier technology of using desk mounted cables and desk mounted brackets required drilling into dormitory furniture, which was not only poorly secured, but was generally not allowed by dormitory authorities.

This invention will provide totally keyless electronic access to a security apparatus for laptop computers and provide for easy surface mounting and secure easy removal of a properly sized lightweight, secure enclosure for laptop computers

### BRIEF SUMMARY OF THE INVENTION

The primary object of the invention is to provide a better security apparatus for laptop computers.

Another object of the invention is to provide totally keyless electronic access to a security apparatus for laptop computers.

Another object of the invention is to provide for easy surface mounting and secure easy removal of a properly sized lightweight, secure enclosure for laptop computers.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for preventing the theft of laptop computers. comprising: a self contained secure enclosure for a laptop computer, a way to mount the enclosure in a vertical orientation, a keyless mechanism to access enclosure, a way to better prevent access to the security enclosure, a way to notify the owner of unauthorized access to the enclosure, a way to notify the owner of unauthorized attempts to access the enclosure, a way to limit access to enclosure to authorized personnel, a way to determine which authorized personnel have accessed the secure enclosure, a way to provide authorized emergency access to the enclosure, a way to enhance backup electrical power for the enclosure, and a way to notify the owner of reduced available electrical power.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the front door assembly of the invention.

FIG. 3 is an exploded view of the stationary outer enclosure of the invention.

FIG. 4 is a perspective view of the back panel of the front access door of the invention.

FIG. 5 is a perspective view of the reverse side of FIG. 4.

FIG. 6 is a perspective view of the retractable locking pin attached to the surface mounting plate for the invention.

FIG. 7a is a descriptive schematic diagram illustrating keystroke entry for the digital electronic data processing system.

FIG. 7b is a continuation of FIG. 7a.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

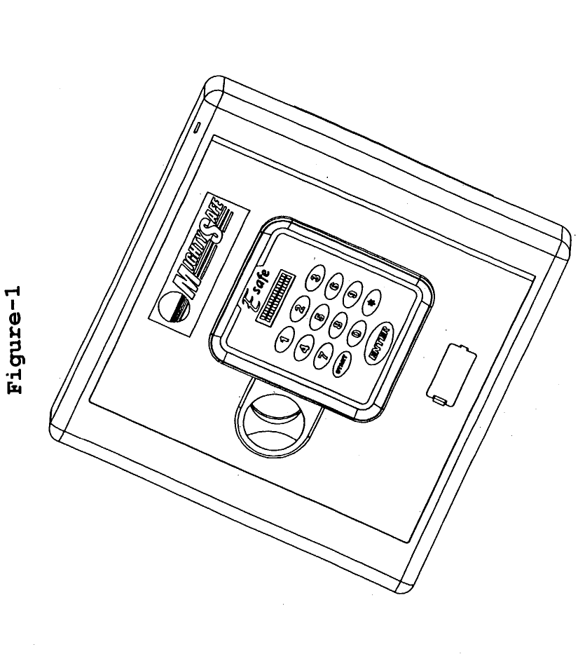

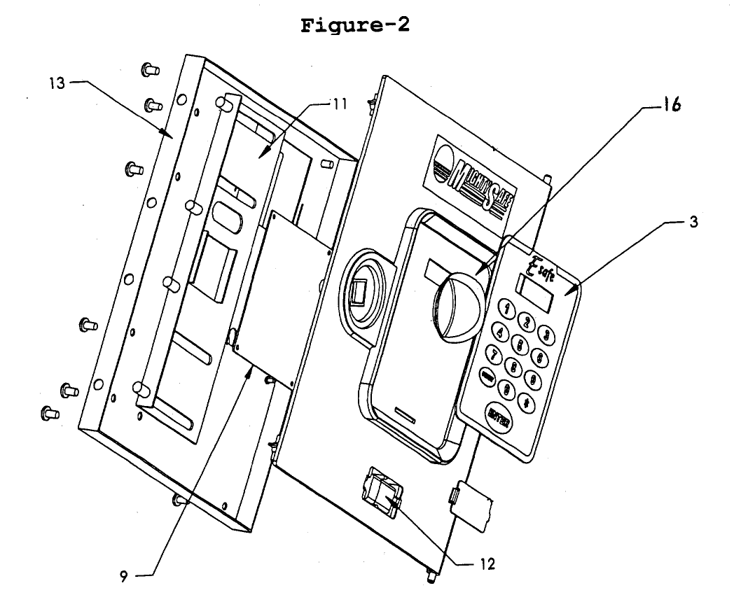

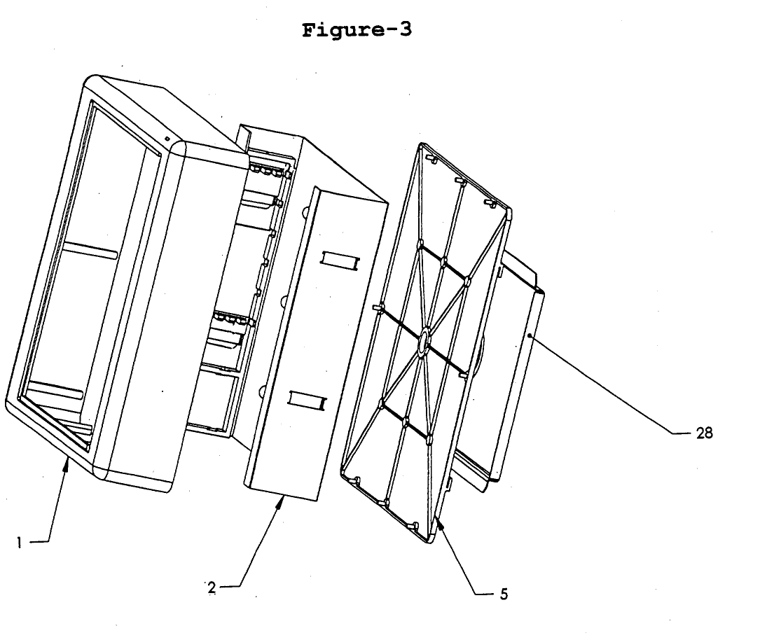

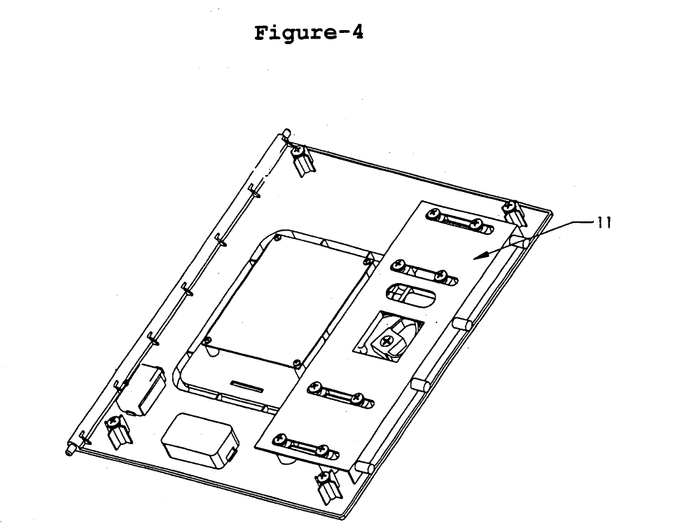

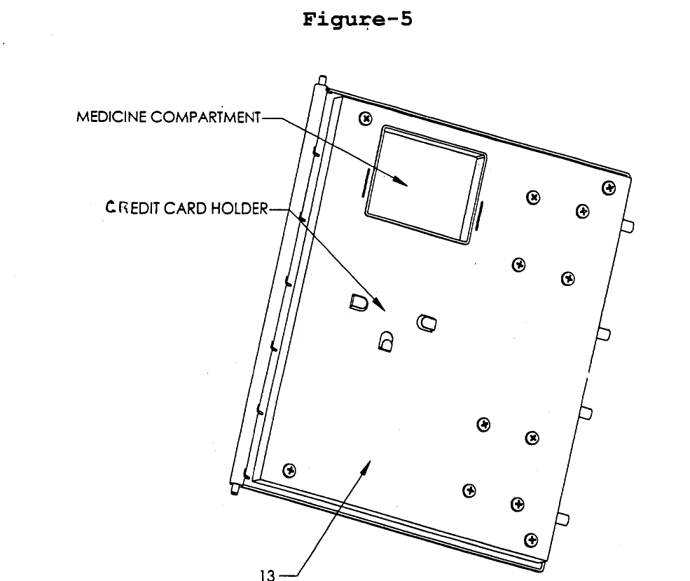

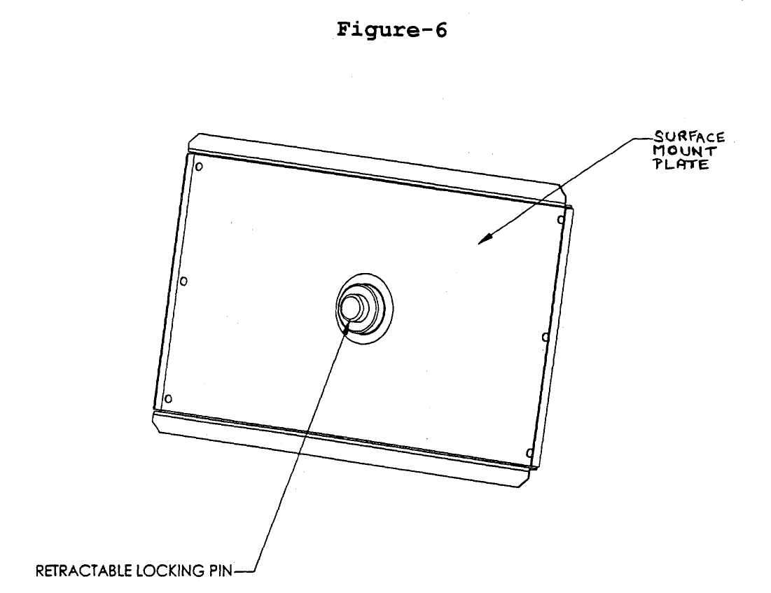

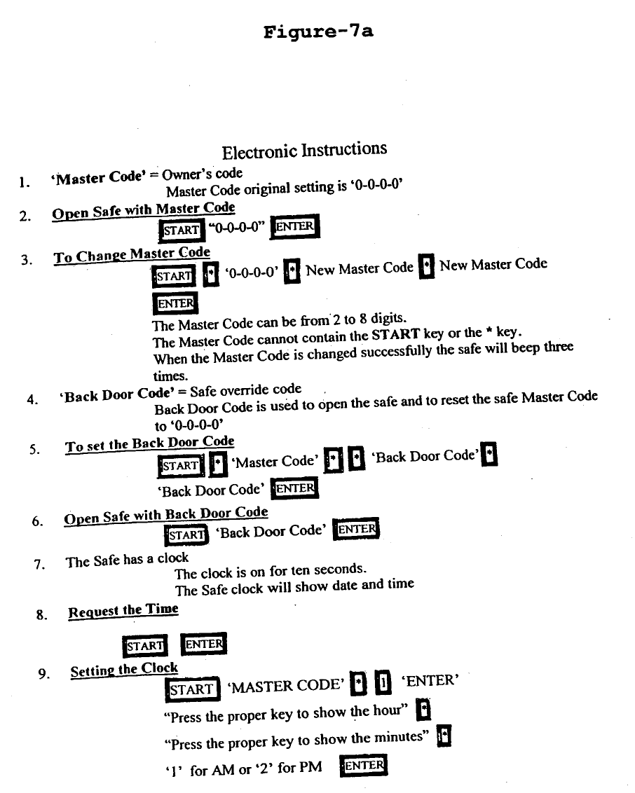

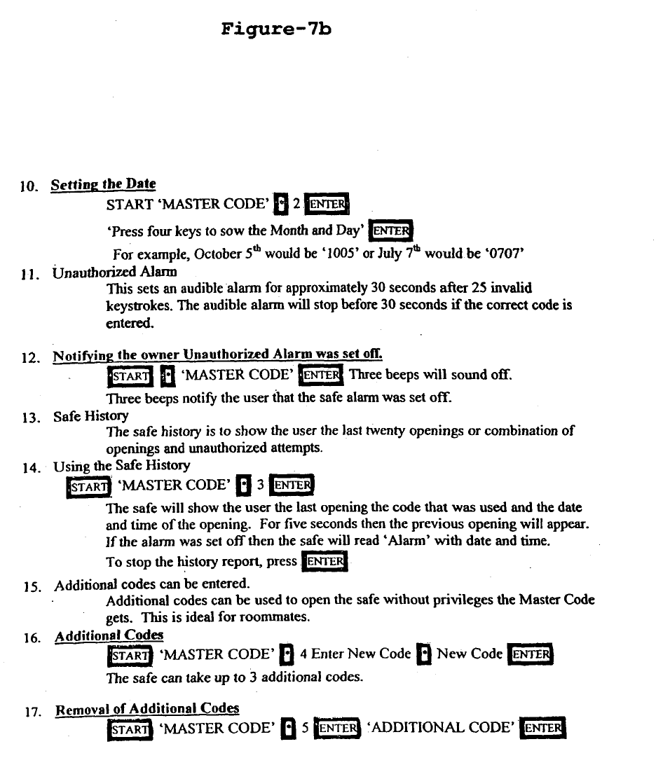

Turning first to FIG. 1 there is shown the preferred embodiment of the invention. This is a perspective view of the front of the invention as a user would face it. In the center of the figure is the digital touch keypad for entry of access codes. FIG. 2 is an exploded view of the front door assembly of the invention, wherein part No. 3 is the keypad, part No. 12 represents the independent 9 volt battery power to power the keypad. Part No. 16 is the knob which a user would turn counterclockwise to open the front door of the secure enclosure only after the correct access code had been entered on the adjacent keypad. Part No. 9 is the coverplate over the cam mechanism which, when rotated, slides part No. 11 so as to withdraw the four steel roundbars from their guide holes located in part 13. FIG. 3 is an exploded view of the stationary outer enclosure of the invention, wherein part No. 28 is the main base foundation plate which would be hard mounted with suitable fasteners to a secure vertical surface such as a wall. Part is more illustratively shown in FIG. 6. Part No.'s 1, 2 and 5 together provide the outer stationary enclosure for the invention. This assembly is configured such that through a center hole in its rear, the retractable locking pin of part No. 28 passes, thereby allowing the entire enclosure to be quickly and easily removed from the mounting surface plate No. 28. Note that one cannot obtain access to this retractable locking pin without first having opened the front access door of the enclosure by entry of the proper codes to the toch keypad on the front of the front access door panel. FIG. 4 is a perspective view of the back panel of the front access door of the invention. Part No. 11 is the slide plate that attaches to a slides the four steel round bars to lock the enclosure. This slide plate covers the cam actuating mechanism for this slide plate. FIG. 5 is a perspective view of the reverse side of FIG. 4. When the front access door of the enclosure is swung open by the user, this rear side of the front access door would be exposed and, seen by the user. The user has the additional option of placing medications and credit cards in fixtures places on this front door rear panel, therby permitting additional uses for the invention. FIG. 6 is a perspective view of the retractable locking pin attached to the surface mounting plate for the invention. As discussed, this mounting plate with its retractable pin, is the only piece of the invention that need be permenently mounted on a room wall. This allows interchangeability of units for servicing or security, as when changing students in dormitory rooms at the end of a semester term. FIGS. 7a and 7b are a descriptive schematic diagrams illustrating keystroke entry for the digital electronic data processing system. The software for the keypad electronics allows the entry of one owner access code, plus provision for five other codes authorized by the owner for additonal approved access. In case the owner misplaces or forgets his master code, there is an emergency access “backdoor” code which can be maintained for the particular unit at another location, such as campus security at a college. The keypad electronics has a real time clock operation thereby permitting the electronic event logging. The electronics will archive the use history, thereby advising the owner of the timing and frequency of past accesses by other authorized users. The electronics will also sound an audible alarm if there repetitive unsuccessful attempts at accessing the unit through numerous keystrokes. The electronics will warn if the reserve electrical power for the unit is low. The electronics will also maintain an event log of this information for later retrieval.

The invention describes an apparatus or device for preventing the theft of laptop computers from theft. comprising a self contained secure enclosure for a laptop computer; a way to mount the enclosure in a vertical orientation; a keyless mechanism to access enclosure; a way to better prevent access to the security enclosure; a way to notify the owner of unauthorized access to the enclosure; a way to notify the owner of unauthorized attempts to access the enclosure; a way to limit access to enclosure to authorized personnel; a way to determine which authorized personnel have accessed the secure enclosure; a way to provide authorized emergency access to the enclosure; a way to enhance backup electrical power for the enclosure; and a way to notify the owner of reduced available electrical power.

The present invention illustrates an apparatus or device for preventing the theft of laptop computers from theft. This is accomplished by providing a self contained secure enclosure for a laptop computer, thereby elliminating the need for furniture mounted cables and brackets existing in the prior art. The invention provides a way to mount the enclosure in a vertical orientation on a more secure surface than a portable piece of furniture used in the prior art. The invention provides a keyless mechanism to access enclosure thereby eliminating the problem with lost or stolen keys used in the prior art. Given the herein described capabilities of the software in the keypad electronics system (as illustrated in FIG. 7a-7b), the invention is an improvement on the prior art since the invention provides a way to better prevent access to the security enclosure, a way to notify the owner of unauthorized access to the enclosure, a way to notify the owner of unauthorized attempts to access the enclosure, a way to limit access to enclosure to authorized personnel, a way to determine which authorized personnel have accessed the secure enclosure, a way to provide authorized emergency access to the enclosure, a way to enhance backup electrical power for the enclosure, and away to notify the owner of reduced available electrical power.

The invention may be used to secure a laptop computer, hand held personal electronic devices, personal medicines and credit cards.

Therefore, the invention provides a better security apparatus for laptop personal computers, it provides totally keyless electronic access to a security apparatus for laptop computers, and it provides for easy surface mounting and secure easy removal of a properly sized lightweight, secure enclosure for laptop computers.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for preventing the theft of laptop computers. comprising:
a self contained secure enclosure for a laptop computer;
a way to mount the enclosure in a vertical orientation;
a keyless mechanism to access enclosure;
a way to better prevent access to the security enclosure;
a way to notify the owner of unauthorized access to the enclosure;
a way to notify the owner of unauthorized attempts to access the enclosure;
a way to limit access to enclosure to authorized personnel;
a way to determine which authorized personnel have accessed the secure enclosure;
a way to provide authorized emergency access to the enclosure;
a way to enhance backup electrical power for the enclosure; and
a way to notify the owner of reduced available electrical power.
